(19) United States
(12) Patent Application Publication
(10) Pub. No.: US 2021/0294827 A1
(43) Pub. Date: Sep. 23, 2021

(54) INFORMATION PROCESSING APPARATUS, INFORMATION PROCESSING METHOD, AND NON-TRANSITORY COMPUTER READABLE MEDIUM

(71) Applicant: KABUSHIKI KAISHA TOSHIBA, Tokyo (JP)

(72) Inventors: Eiichi SUNAGAWA, Ota Tokyo (JP); Shinichi NAGANO, Yokohama Kanagawa (JP)

(73) Assignee: KABUSHIKI KAISHA TOSHIBA, Tokyo (JP)

(21) Appl. No.: 17/015,665

(22) Filed: Sep. 9, 2020

(30) Foreign Application Priority Data
Mar. 18, 2020 (JP) 2020-047893

(51) Int. Cl. G06F 16/31; G06F 16/383; G06F 16/35; G06F 16/33

(52) U.S. Cl. CPC G06F 16/322; G06F 16/3335; G06F 16/355; G06F 16/383

(57) ABSTRACT

One embodiment of the present invention provides an information processing apparatus that transforms a text into data indicating entities and association among entities, compares the transformed data, and thereby enables texts having a relationship to be detected. An information processing apparatus as one embodiment of the present invention includes: a transformer; and a detector. The transformer is configured to transform a text into entity data indicating entities and association among entities. The detector is configured to detect a second text having a relationship with a first text by comparing first entity data transformed from the first text with one or more second entity data transformed from one or more second texts.

### CROSS-REFERENCE TO RELATED APPLICATION (S)

This application is based upon and claims the benefit of priority from Japanese Patent Application No. 2020-047893, filed Mar. 18, 2020; the entire contents of which are incorporated herein by reference.

### FIELD

Embodiments described herein relate generally to an information processing apparatus, an information processing method, and a non-transitory computer readable medium.

### BACKGROUND

In product development and so forth, existing resources are reused for efficiency. For example, in a circumstance in which plural similar products are developed as represented by derivative development, a specification or a procedure manual of new product development is created by revising a portion of a specification or a procedure manual of previous product development. For the revision, it is necessary to recognize the correspondence relationship between document contents of a previous product and document contents of a product to be newly developed. That is, comprehension of the same portions or different portions among plural documents is demanded.

For the comprehension, in related art, a technique of character string matching or the like such as a diff command has been used which detects different points of a document as a comparison target. However, in related art, when a described part, an appearance order, or the like of a character string described in a document is different, it is difficult to detect even a part in which character strings match each other. In addition, it is not possible to recognize whether contents match each other. Thus, in the current circumstance, reuse of existing resources does not necessarily lead to efficiency, and a technique has been demanded which performs comparison based on contents.

### BRIEF DESCRIPTION OF THE DRAWINGS

FIG. 1 is a block diagram illustrating one example of an information processing apparatus according to one embodiment of the present invention;

FIG. 2 is a diagram explaining an expression form about entities;

FIG. 3 is a diagram illustrating one example of document data;

FIGS. 4A to 4C are diagrams explaining shaping of an entity tree;

FIGS. 5A and 5B are diagrams illustrating one example of data about a stored entity tree;

FIGS. 6A and 6B are diagrams illustrating one example of data about correspondence relationships among texts, entities, and entity relationships;

FIG. 7 is a diagram illustrating one example of an interface for accepting designation of a partial range of an entity tree;

FIG. 8 is a diagram illustrating one example of an output result;

FIG. 9 is a diagram illustrating a first example of display of a synthetic tree;

FIG. 10 is a diagram illustrating a second example of display of a synthetic tree;

FIG. 11 is a diagram illustrating a third example of display of a synthetic tree;

FIG. 12 is a diagram illustrating a fourth example of display of a synthetic tree;

FIG. 13 is a diagram illustrating a fifth example of display of a synthetic tree;

FIG. 14 is an outline flowchart of transformation processing;

FIG. 15 is an outline flowchart of detection processing; and

FIG. 16 is a block diagram illustrating one example of a hardware configuration of one embodiment of the present invention.

### DETAILED DESCRIPTION

One embodiment of the present invention provides an information processing apparatus that transforms a text into data indicating entities and association among entities, compares the transformed data, and thereby enables texts having a relationship to be detected.

An information processing apparatus as one embodiment of the present invention includes: a transformer; and a detector. The transformer is configured to transform a text into entity data indicating entities and association among entities. The detector is configured to detect a second text having a relationship with a first text by comparing first entity data transformed from the first text with one or more second entity data transformed from one or more second texts.

Below, a description is given of embodiments of the present invention with reference to the drawings. The present invention is not limited to the embodiments.

### First Embodiment

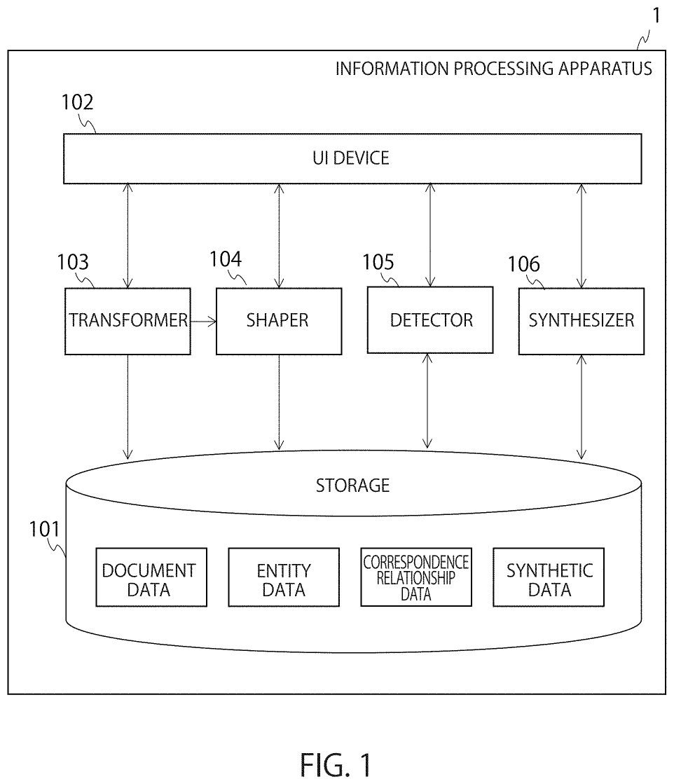

FIG. 1 is a block diagram illustrating one example of an information processing apparatus according to one embodiment of the present invention. An information processing apparatus 1 related to this embodiment includes a storage 101, a UI device (input-output device) 102, a transformer 103, a shaper 104, a detector 105, and a synthesizer 106.

The information processing apparatus 1 of this embodiment is an apparatus expressing a text in a document by using entities and association among entities. In other words, the information processing apparatus 1 transforms an expression form as a text into an expression form about entities. An entity is an element making up the meaning of a text. The transformation facilitates logical grasping of the meaning of a text.

Note that “document” in this description means an electronic document readable by the information processing apparatus 1.

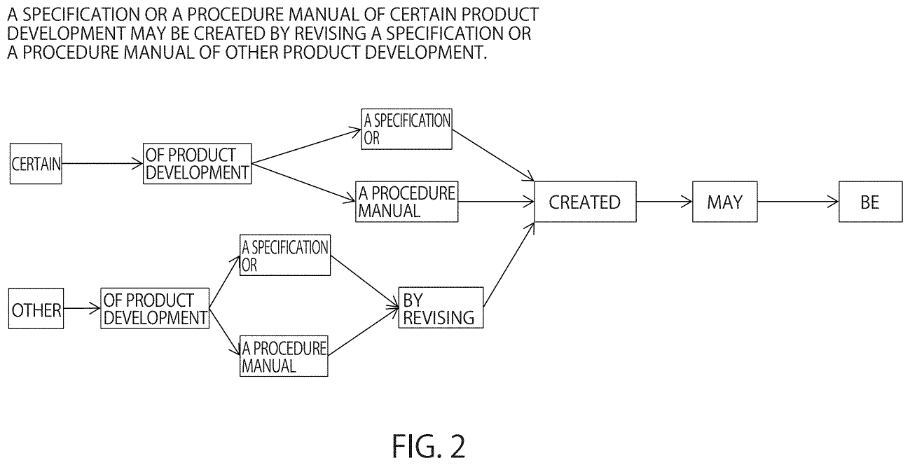

FIG. 2 is a diagram explaining an expression form about entities. The upper side of FIG. 2 indicates a text to be processed by the information processing apparatus 1. The lower side of FIG. 2 illustrates a graph (network) schematically illustrating constituent elements of the text and the relationships of syntactic dependency. A rectangle in the graph represents a constituent element, and an arrow represents syntactic dependency.

The constituent element in the graph in FIG. 2 corresponds to an entity, and the relationship of syntactic dependency corresponds to the association between entities. That is, the graph illustrates the expression form about the entities that is transformed from the text. Note that as described later, the transformation illustrated in FIG. 2 is one example, and further transformation (shaping) is performed. An entity and association between entities respectively correspond to a node and a link in graph theory. Based on such transformation, the meaning of a text may be considered to be a graph, as illustrated in the lower side of FIG. 2, in a tree structure formed with entities and entity relationships. In this description, the graph will be denoted as “entity tree”. Further, association between entities will be denoted as “entity relationship”.

As described above, the information processing apparatus 1 of this embodiment analyzes a document as a processing target and transforms a text included in the document into an entity tree. Then, the information processing apparatus 1 performs various kinds of processing by using the entity tree.

For example, the information processing apparatus 1 analyzes a first document and a second document and generates a first entity tree of a first text included in the first document and a second entity tree of a second text included in the second document. Then, the information processing apparatus 1 compares the first entity tree with the second entity tree and thereby detects a common portion or the like. Accordingly, an assessment may be made that the first text and the second text include portions matching each other in terms of content, for example. Further, a common entity may be output. In such a manner, document search based on a content is enabled which is not possible by simple character string matching.

Details of processing by the information processing apparatus 1 will be described together with an internal configuration thereof. Note that each constituent element of the information processing apparatus 1 illustrated in FIG. 1 may be subdivided or integrated. Further, the information processing apparatus 1 may have a constituent element not illustrated in FIG. 1.

For example, an apparatus including the transformer 103 and transforming a text and an apparatus including the detector 105 and performing search may separately be provided. Further, for example, data used for processing by the information processing apparatus 1 may be stored in a storage such as a network area storage. That is, the storage 101 may be present on the outside of the information processing apparatus 1. Further, the UI device 102 may be split into an input device and an output device.

Such division into apparatuses performing respective kinds of processing in a specialized manner is often made in an information processing system in order to disperse a processing load, to maintain availability, and so forth. That is, the information processing apparatus 1 may be an apparatus operating individually or may be an apparatus (system) of a server-client model, the apparatus cooperating with a server on a communication network such as a cloud.

The storage 101 stores data input to the information processing apparatus 1, data used by each constituent element, a processing result by each constituent element, and so forth. Data stored in the storage 101 are not particularly limited.

The UI device 102 accepts an input of information used for processing by the information processing apparatus 1 and outputs a processing result by the information processing apparatus 1. For example, the UI device 102 acquires a text or a document and stores that in the storage 101.

The UI device 102 may be a graphical user interface (GUI) displaying a web form or the like for accepting a text or a document, for example. Alternatively, the UI device 102 may be a communication device performing transmission and reception of data with an EXTERNAL DEVICE. Further, an output format of the UI device 102 is not particularly limited. For example, the UI device 102 may output an image such as a web form or may extract a file in which a processing result by each constituent element is described from the storage 101 and output the file.

Further, the UI device 102 accepts a search condition and notifies that to the detector 105. A search result based on the search condition is notified from the detector 105, and the UI device 102 outputs the search result. Examples of the search result may include a detected entity, a text or document corresponding to a detected entity, and so forth.

The transformer 103 extracts a text described in the document obtained via the UI device 102. Here, the transformer 103 may divide the text into each predetermined unit such as a sentence or a paragraph. Note that in a case where a text of each predetermined unit is accepted from the UI device 102, the processing may be skipped. Further, in a case where one text is dealt with for the whole document, the processing may be skipped. A known extraction command or the like may be used for extraction of a text in a document.

To the text of each predetermined unit, information for identifying the text, information indicating the document in which the text is described, or the like are given, and the text of each predetermined unit is stored in the storage 101. Such data about a recognized text will be denoted as “document data”.

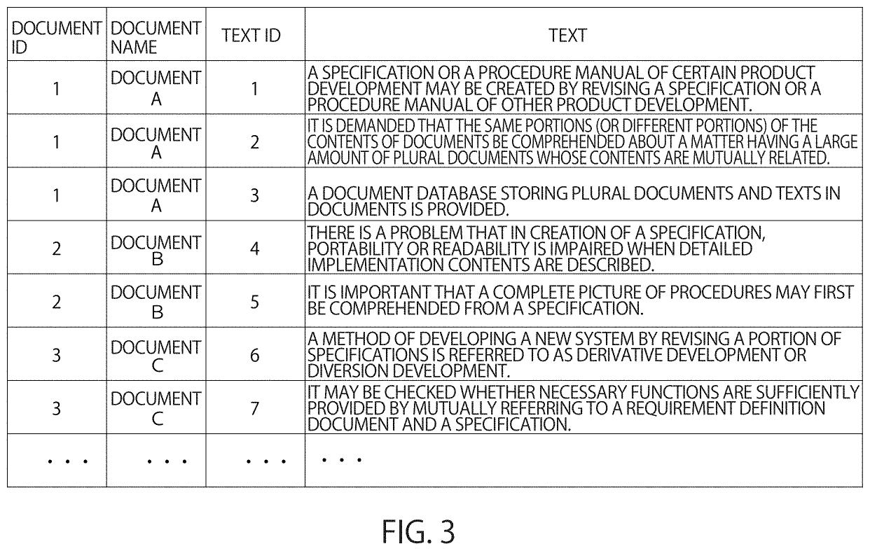

FIG. 3 is a diagram illustrating one example of the document data. The document data includes at least information about a text and a document including the text. For example, it is indicated that an ID (text ID) of “1” is given to the text indicated in the second row from the top of the table of FIG. 3. Further, it is indicated that the text is included in a document A and an ID (document ID) of the document A is “1”. Information other than the information indicated in FIG. 3 may be included in the document data. For example, information indicating a place such as a chapter in which the text is described, a creation date of the document, a creator of the document, and so forth may be included. Those pieces of information may be accepted together with an input of the document, and the document ID and so forth may be given by the information processing apparatus 1 itself.

The transformer 103 detects entities and entity relationships from a text of a predetermined unit and transforms the text into an entity tree. The entity tree is stored in the storage 101 together with information indicating the text corresponding to the entity tree, in other words, the text as a base of the entity tree.

A known technique may be used as a method of detecting entities and entity relationships from a text. For example, a target text is decomposed into morphemes by using a morphological analysis technique, and then a compound or the like formed with a morpheme or a series of morphemes (morpheme string) is set as an entity, and an inclusion relationship between entities may be set as an entity relationship. Alternatively, a target text is divided into phrases formed with morpheme strings, and then the phrase is set as an entity, syntactic dependency between entities is recognized by using known syntactic dependency analysis software or the like, and the recognized syntactic dependency relationship may be set as an entity relationship. Further, entities and entity relationships may be acquired by using external information such as ontology.

An entity tree may include all entities obtained by an analysis or may selectively include only entities satisfying a certain condition by limiting entities to a range of a part of speech in advance designated, for example.

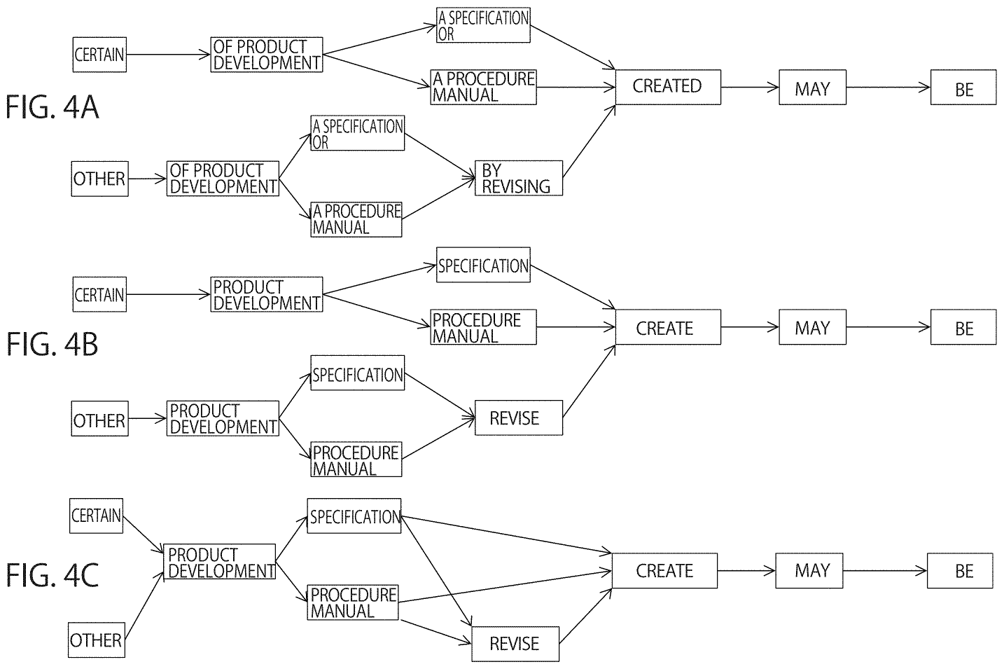

Further, in this embodiment, the shaper 104 shapes an entity tree. FIGS. 4A to 4C are diagrams explaining shaping of an entity tree. An entity tree illustrated in FIG. 4A is the same as the entity tree illustrated in FIG. 2. An entity tree illustrated in FIG. 4B is an entity tree in which a portion other than a morpheme of a noun or a verb included in each entity of the entity tree illustrated in FIG. 4A is deleted. For example, an entity of “SEIHINKAIHATSU NO (of product development)” in FIG. 4A is changed to “SEIHINKAIHATSU (product development)” in FIG. 4B.

An entity tree illustrated in FIG. 4C is an entity tree in which the same entities illustrated in FIG. 4B are integrated into one entity. For example, although the entity tree of FIG. 4B includes two entities of “SEIHINKAIHATSU (product development)”, the two entities are integrated into one entity in FIG. 4C. Through such shaping, the meaning of even a long text may be summarized. Note that in a case where the same entities are integrated together as in FIG. 4C, the number or the like of same entities not yet integrated is counted, and the number may be recorded in the storage 101.

Note that integration may not be performed in a case where the same character strings correspond to different parts of speech. For example, FIG. 4C indicates two character strings of “ARU”. However, one of those is an adnominal adjective modifying “SEIHINKAIHATSU (product development), and the other is a verb meaning “presence”. Thus, those two entities do not have to be integrated together.

Note that it is possible that entities are integrated together even if character strings are different. For example, a case is possible where different notations indicate the same object. Further, there are many words having different names but representing the same object such as “specification” and “standard documentation”. Thus, different character strings that may be considered to be the same may be integrated together. Whether or not different characters are considered to be the same may be determined by referring to dictionary data used as criteria for determination. The dictionary data may in advance be stored in the storage 101 or may be received from an EXTERNAL DEVICE different from the information processing apparatus 1. Alternatively, character strings as entities are transmitted to an EXTERNAL DEVICE, and data indicating entities that may be integrated together may be received.

Further, in a case where entities are integrated together, entities may be integrated together regardless of the positions in an entity tree, and entities whose positions in an entity tree are separated by a predetermined hop count or more may not be integrated together. The predetermined hop count may appropriately be adjusted.

Further, in the above, entities included in an entity tree of a text are integrated together; however, the entity trees of texts included in the same document may be integrated together. A condition for integrating entities together as the same entity may appropriately be defined. For example, texts with text IDs of “1” to “3” indicated in FIG. 3 are described in the same document A. Thus, the entities with the text IDs of “1” to “3” may be considered to be common entities and may be integrated together as illustrated in FIG. 4C.

Entities and entity relationships of an entity tree may be used as information indicating characteristics of a text. For example, when texts are compared with each other, a matching degree or the like between the compared texts may be assessed in accordance with the ratio of inclusion of common entities and entity relationships or the like.

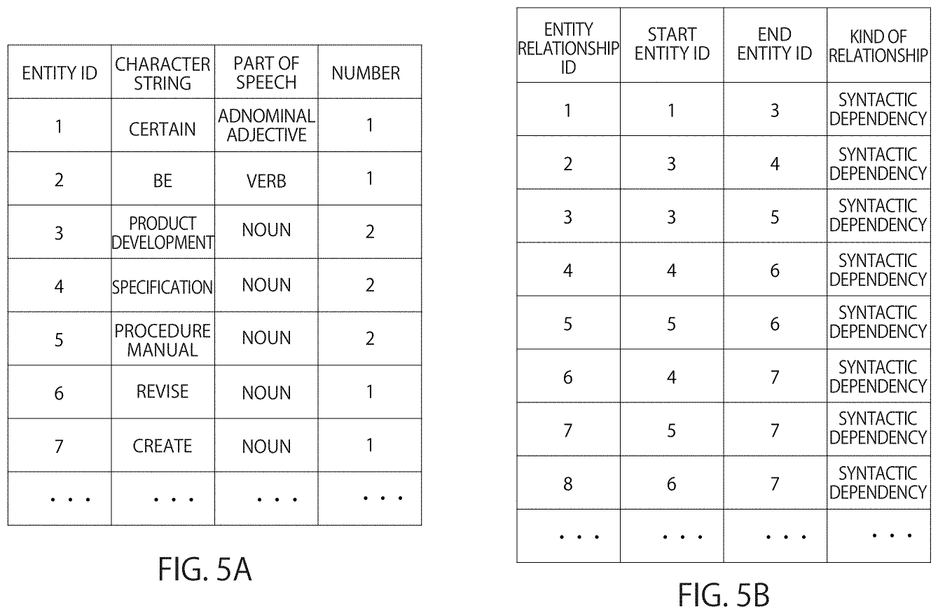

An entity tree is stored by the storage 101. Note that an entity tree not yet shaped and an entity tree already shaped may separately be stored. FIGS. 5A and 5B are diagrams illustrating one example of data about a stored entity tree. The data will be denoted as “entity data”. The entity data may be considered to be data representing an entity tree.

FIG. 5A is a diagram illustrating one example of data about entities in an entity tree. An ID (entity ID) is given to each entity in the entity tree illustrated in FIG. 4C. Further, the entity ID is associated with information such as the part of speech of a character string as an entity and the number of entities included in the entity tree before the same entities are integrated together.

FIG. 5B is a diagram illustrating one example of data about entity relationships in an entity tree. The numerals indicated by a start entity ID and an end entity ID are the entity IDs indicated in FIG. 5A. The start entity ID corresponds to a modifying entity in an entity relationship and to an entity on a start side of an arrow illustrated in FIG. 4C. The end entity ID corresponds to a modified entity in an entity relationship and to an entity on an end side of an arrow illustrated in FIG. 4C. For example, the entity relationship with an entity relationship ID of “3” indicates that an entity of “SEIHINKAIHATSU (product development)” with an entity ID of “3” explains an entity of “TEJUNSYO (procedure manual)” with an entity ID of “5”.

As described above, the entity data are stored in a format that may express an entity tree.

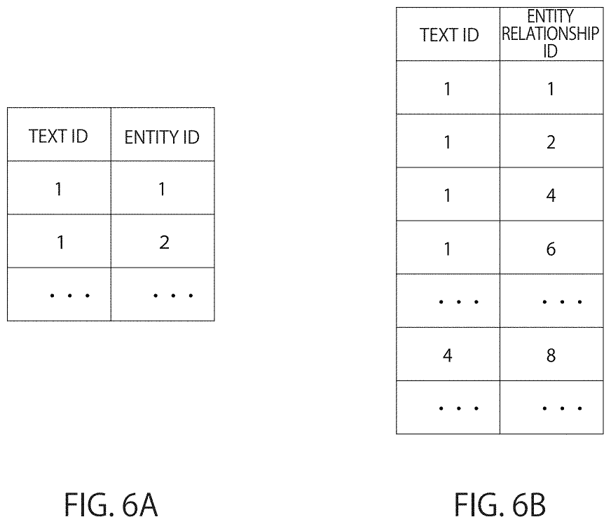

Further, as described above, an entity tree is stored in the storage 101 together with information indicating a corresponding text. FIGS. 6A and 6B are diagrams illustrating one example of data about correspondence relationships among texts, entities, and entities relationships. In the following, the data will be denoted as “correspondence relationship data”.

FIG. 6A indicates the correspondence relationships between entities and texts by using the entity IDs indicated in FIG. 5A and the IDs of texts (text IDs). FIG. 6B indicates the correspondence relationships between entity relationships and texts by using the entity relationship IDs indicated in FIG. 5B and the text IDs. A manner of indicating the correspondence relationship is not particularly limited but may be a manner in which the correspondence relationship may be recognized, as FIGS. 6A and 6B.

As described above, entity data corresponding to each text are stored in the storage 101. That is, a corresponding entity tree is stored for each text.

The detector 105 accepts the search condition via the UI device 102 and detects at least either one of the entity data and text satisfying the search condition from the storage 101.

A description will be made by raising, as an example, a case where the first text is acquired as the search condition and the second text having a relationship with the first text is detected. The detector 105 may detect the text ID of the first text based on the document data. Further, the detector 105 may acquire the entity ID and the entity relationship ID from the detected text ID based on the correspondence relationship data indicated in FIGS. 6A and 6B. That is, the first entity tree of the first text is recognized. In addition, the detector 105 may specify an entity tree including a portion of the acquired entity ID and entity relationship ID based on the entity data indicated in FIGS. 5A and 5B. In other words, the first entity tree is compared with other entity trees, and the second entity tree is thereby recognized which satisfies a condition such as including a common portion to the first entity tree. Then, the detector 105 may detect the second text corresponding to the second entity tree based on the document data. In such a manner, the second text related to the first text may be detected.

Because the entity trees of the first text and the second text have a common portion, the first text and the second text are estimated to include a portion with a common content. Thus, the second text is output as a document that matches the first text in terms of content. Such search may be considered to be search based on a content of a document, and the first text and the second text may be considered to have a relationship in terms of content.

Note that in the above, a case where the first text is acquired and the second text having a relationship with the first text is detected is given as an example; however, detection of entity data from a text may be targeted, or detection of a text from entity data may be targeted. That is, only processing corresponding to a portion of the above course of detection of the second text from the first text may be executed.

Note that in the above example, in a case where an entity tree including a portion of an entity ID and an entity relationship ID is specified, designation of a partial range of the entity tree of the first text is accepted, and an entity tree including entity and entity relationship included in the designated range may thereby be detected.

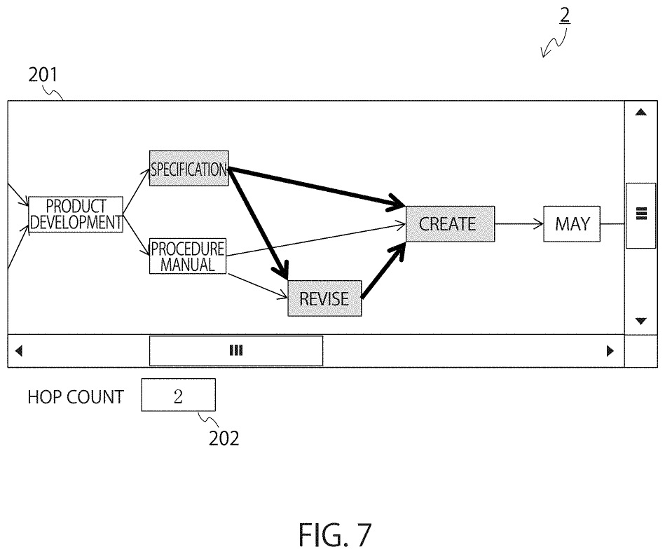

FIG. 7 is a diagram illustrating one example of an interface for accepting designation of a partial range of an entity tree. The interface is displayed by the UI device 102. In the example of FIG. 7, the interface includes an entity display area 201 and a hop count input area 202.

The entity display area 201 is a portion for displaying entity data. As in FIG. 7, an entity tree may be displayed, or the data indicated in FIGS. 5A, 5B, 6A, and 6B may be displayed.

The hop count input area 202 accepts designation of a range of tracing from an entity as a reference. In the example of FIG. 7, a numeral of “2” is input as the hop count in a box illustrated on a right side of the character string of “HOP COUNT”.

Further, selection of the entity as the reference may be accepted via the entity display area 201. FIG. 7 illustrates an example where an entity of “SHIYOSYO (specification)” is selected from the entities included in the displayed entity tree. The rectangle indicating selected “SHIYOSYO (specification)” is displayed in gray. Further, because a hop count of “2” is designated, the entities and entity relationships within a hop count of “2” from the entity of “SHIYOSYO (specification)” are set as the search conditions for detecting texts having relationships. Based on the entity and hop count accepted in such a manner, the search condition for detecting a text having a relationship may be determined.

Note that in the example of FIG. 7, movement of two hops from the entity as the reference in an advancing direction is set. Thus, in the example of FIG. 7, entities of “SAKUSEI (create)” and “KAITEI (revise)” within two hops from “SHIYOSYO (specification)” in the advancing direction are selected, and the frames indicating those are also displayed in gray. Note that the display of the selected entities and entity relationships is not particularly limited as long as the display is different such that the selected entities and entity relationships may be distinguished from the others.

Note that in the example of FIG. 7, three entity relationships of the entity relationship from “SHIYOSYO (specification)” to “KAITEI (revise)”, the entity relationship of “SHIYOSYO (specification)” to “SAKUSEI (create)”, and the entity relationship of “KAITEI (revise)” to “SAKUSEI (create)” are selected; however, inclusion of any one of the selected entity relationships may be set as the search condition, or inclusion of all of those may be set as the search condition.

Note that the above three entity relationships correspond to the entity relationships with the entity relationship IDs of “4”, “6”, and “8”, which are indicated in FIG. 5B. The detector 105 may recognize those entity relationship IDs based on the entity data and may further detect the text IDs “1” and “4” corresponding to those entity relationship IDs based on the correspondence relationship data indicated of FIG. 6B. In addition, the texts of the text IDs “1” and “4” and the corresponding document IDs may be acquired based on the document data indicated in FIG. 3.

Note that designation of the search condition is not limited to the example of FIG. 7. For example, plural sets of entity data are output, selected entity data are accepted, and the entity data and text having a relationship with the selected entity data may thereby be output. Further, a target to be detected may be changed in accordance with a setting, a condition, and so forth of search.

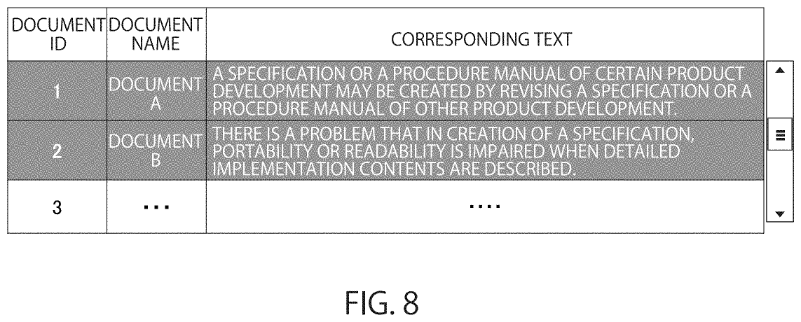

FIG. 8 is a diagram illustrating one example of an output result. The output result may indicate texts including the entity relationships included in the search conditions. FIG. 8 indicates information about the texts with the text IDs of “1” and “4” acquired in the above-described example. Note that texts not including the designated entity do not have to be output. Alternatively, the texts not including the designated entity may be displayed in a form in which those are distinguishable from texts including the designated entity. For example, the texts including the designated entity may be displayed by using a different color such that those may be distinguished from the others. In the example of FIG. 8, the texts including the designated entity are displayed by white characters.

As the output of the information processing apparatus 1, various other forms are possible. In the following, several display examples by using synthetic entity data based on plural entity data will be introduced.

The synthesizer 106 generates synthetic entity data by integrating together entities included in plural sets of entity data. For example, an entity tree corresponding to plural designated texts may be synthesized. Alternatively, synthesis may be performed between the first entity tree of the first text used in the search and the second entity tree of the detected second text. Note that the number of entity trees to be integrated together is not particularly limited. Note that an integration method may be the same as shaping processing of entity data. Further, the correspondence relationship data for synthetic entity data are created in the same manner as entity data. An entity tree represented by synthetic entity data will be denoted as “synthetic tree”.

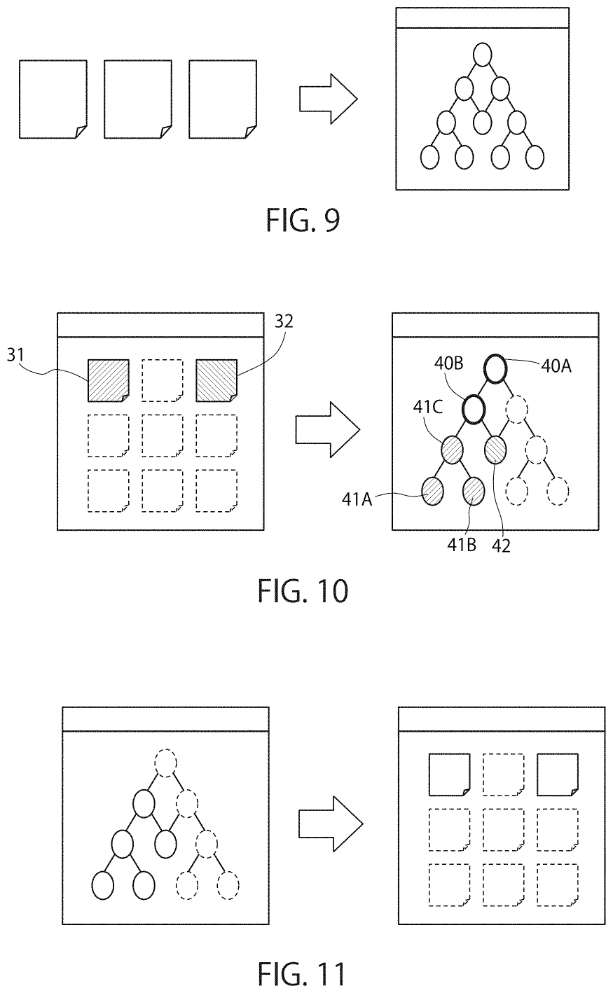

FIG. 9 is a diagram illustrating a first example of display of a synthetic tree. FIG. 9 indicates that plural texts or documents recognized as having relationships are displayed and thereafter a synthetic tree generated by synthesizing an entity tree from those texts is displayed. Note that both of the plural texts or documents and the synthetic tree may be displayed at the same time.

FIG. 10 is a diagram illustrating a second example of display of a synthetic tree. FIG. 10 is the same as FIG. 9 in the point that a synthetic tree is displayed from plural texts or documents. In FIG. 10, further selection from plural texts or documents is accepted, and display of the entities corresponding to the selected texts or documents is changed so as to be different from display of the other entities.

For example, in a case where two or more texts or documents are selected, display of common entities to the selected two texts or documents may be changed so as to be different from display of the other entities. The left side of FIG. 10 indicates that icon 31 and icon 32 representing texts or documents are selected. The icons illustrated by dotted line frames indicate that those are not selected. The right side of FIG. 10 illustrates icon 40A and icon 40B representing common entities to both of the texts or documents of the icon 31 and the icon 32. The breadth of frame lines of the icons 40A and 40B are different from the other icons. Further, icons 41A, 41B, and 41C are illustrated which represent the entities corresponding to the text or document of the icon 31 but not corresponding to the text or document of the icon 32. Further, an icon 42 is illustrated which represents the entity corresponding to the text or document of the icon 32 but not corresponding to the text or document of the icon 31. As illustrated in FIG. 10, those icons are also illustrated in a form in which those are distinguishable from the other icons. In such a manner, display of the entity included only in one text (more accurately, only the entity data of the text) may be changed so as to be different from display of the other entities. Note that the remaining icons which do not correspond to those icons are illustrated by dotted lines. As described above, display of the icon not corresponding to the designated entity may also be changed.

Note that as described above, the relationship between the entities included in the synthetic tree and the text is described in the correspondence relationship data for the synthetic tree. Thus, the detector 105 is capable of detecting an entity related to a selected text from entities of a synthetic tree.

FIG. 11 is a diagram illustrating a third example of display of a synthetic tree. In a reverse way to the example of FIG. 10, in a case where an entity included in a synthetic tree is designated via the UI device 102, the texts or documents corresponding to the designated entity are illustrated. Designation of an entity may be accepted by displaying a GUI as illustrated in FIG. 7 by the UI device 102. When the entity data and the correspondence relationship data are used, the detector 105 may detect, through an entity, the texts or documents including the entity in a reverse way to the example of FIG. 10.

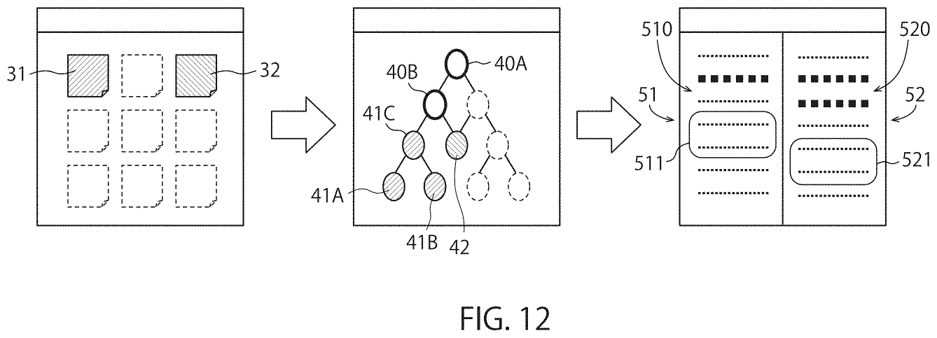

FIG. 12 is a diagram illustrating a fourth example of display of a synthetic tree. Texts are displayed in addition to the second example illustrated in FIG. 10. The texts are indicated in a form in which those may be distinguished from the others such that the parts corresponding to the entities are known. The right side of the example of FIG. 12 illustrates a first display area 51 and a second display area 52. The first display area 51 displays the text corresponding to the icon 31. The second display area 52 displays the text corresponding to the icon 32. A text 510 in the first display area 51 and a text 520 in the second display area 52 are the texts each corresponding to the entities 40A and 40B common to both of the texts represented by the icon 31 and the icon 32 and are indicated by boldfaced characters. A frame line 511 in the first display area 51 surrounds the text corresponding to entities 41A, 41B, and 41C. A frame line 521 in the second display area 52 surrounds the text corresponding to an entity 42. The part corresponding to an entity may be made distinguishable from the others by using such display.

As described above, the relationship between each text and each entity may be recognized by the document data and the correspondence relationship data. That is, the detector 105 is capable of detecting the corresponding entity from a selected text and of detecting the corresponding text from the detected entity.

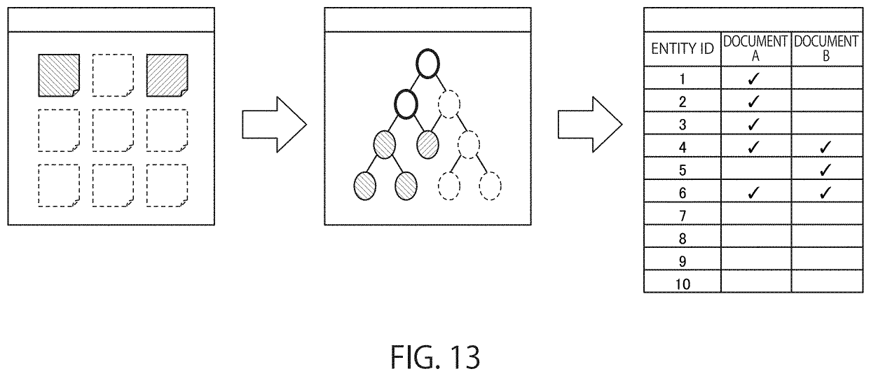

FIG. 13 is a diagram illustrating a fifth example of display of a synthetic tree. FIG. 13 illustrates a table indicating whether or not an entity in a synthetic tree is included in a targeted document. The table indicates, by check signs, that a document A includes entities with entity IDs of “1” to “4” and “6”. The detector 105 may detect the texts including the entities in the same manner as the example of FIG. 10 and detect whether the detected texts are included in each document based on the document data. As in this table, information indicating whether or not an entity included in synthetic entity data is included in a targeted document may be generated and output. Note that a display format of the information is not limited, and a targeted document is not particularly limited.

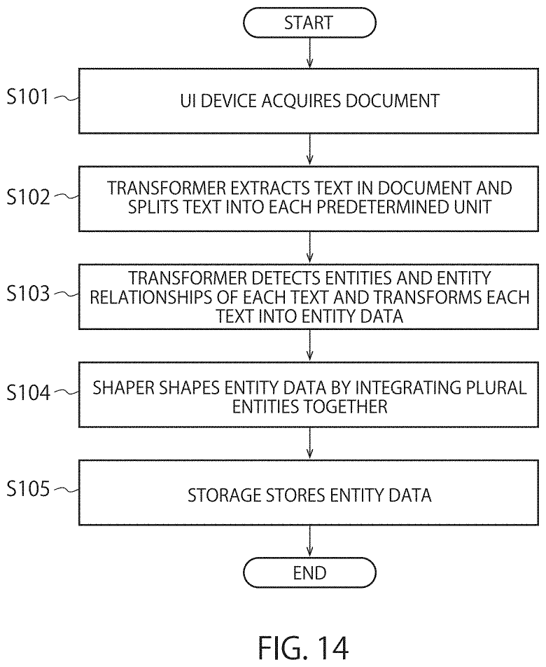

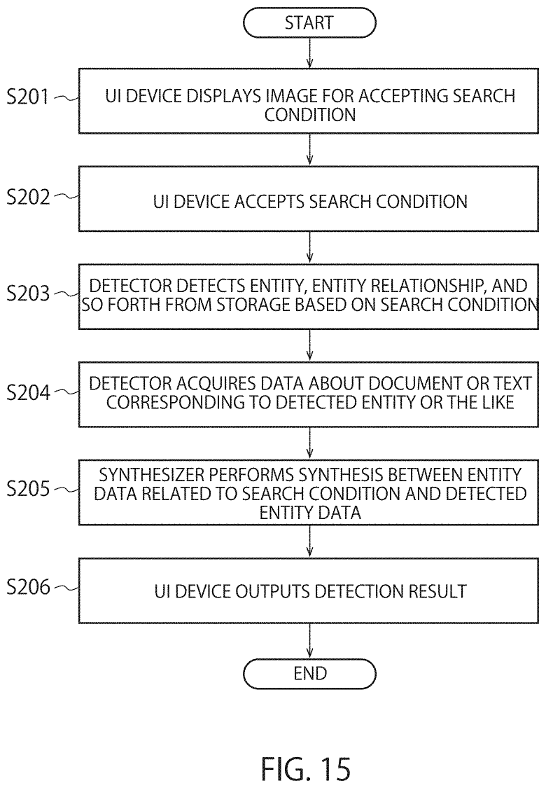

In the following, a flow of processing by the constituent elements of the information processing apparatus 1 will be described. FIG. 14 is an outline flowchart of transformation processing by the information processing apparatus 1 according to this embodiment.

The UI device 102 acquires a document (S101). The transformer 103 extracts a text in the document and splits the text into each predetermined unit (S102). The extracted text is given an identifier or the like and then stored in the storage 101 as document data.

The transformer 103 detects entities and entity relationships of each text (S103). That is, an entity tree indicating entities and association among the entities is generated. The shaper 104 integrates plural entities together and thereby shapes each set of entity data (S104). The entity data transformed as described above and the entity data shaped as described above are stored by the storage 101 (S105), and this flow finishes. This flow is conducted for plural documents, and entity data corresponding to various texts are thereby accumulated.

Next, a flow of search processing will be described. FIG. is an outline flowchart of detection processing by the information processing apparatus 1 according to this embodiment.

The UI device 102 displays an image such as the interface for accepting the search condition (S201). The UI device 102 accepts the search condition (S202). The detector 105 detects entities, entity relationships, or the like satisfying the search condition from the storage 101 (S203).

Then, the detector 105 acquires data about the texts or documents corresponding to the detected entities and so forth based on at least one of entity data, relationship data, and document data (S204). Further, the synthesizer 106 performs synthesis between the entity data related to the search condition and the detected entity data and thereby generates a synthetic tree (S205).

The UI device 102 outputs a detection result as illustrated in FIGS. 8A and 8B to 13 (S206). Then, this flow finishes. Note that the UI device 102 may accept correction to the output. In this case, search may again be performed based on the correction.

Note that this flowchart is one example, and the order or the like of processing is not limited, and a portion of the flowchart may be skipped, as long as a necessary processing result may be obtained. For example, processing of S205 may be skipped in a case where the synthetic tree is not displayed.

As described above, the information processing apparatus 1 of this embodiment generates data indicating an entity tree made up of entities and association among entities from a text in a document. Further, the information processing apparatus 1 executes search based on entity data and thereby enables search based on a content of a text.

Note that at least a portion of the above embodiment may be realized by a dedicated electronic circuit (that is, hardware) such as an integrated circuit (IC) in which a processor, a memory, and so forth are implemented. Further, at least a portion of the above embodiment may be realized by executing software (program). For example, a general purpose computer apparatus is used as a basic hardware, a processor such as a CPU mounted on the computer apparatus is caused to execute a program, and the processing of the above embodiment may thereby be realized.

For example, a computer reads out dedicated software stored in a computer-readable storage medium, and the computer may thereby be used as an apparatus of the above embodiment. Kinds of storage media are not particularly limited. For example, the computer installs dedicated software downloaded via a communication network, and the computer may thereby be used as an apparatus of the above embodiments. Accordingly, information processing by software is specifically implemented by using a hardware resource.

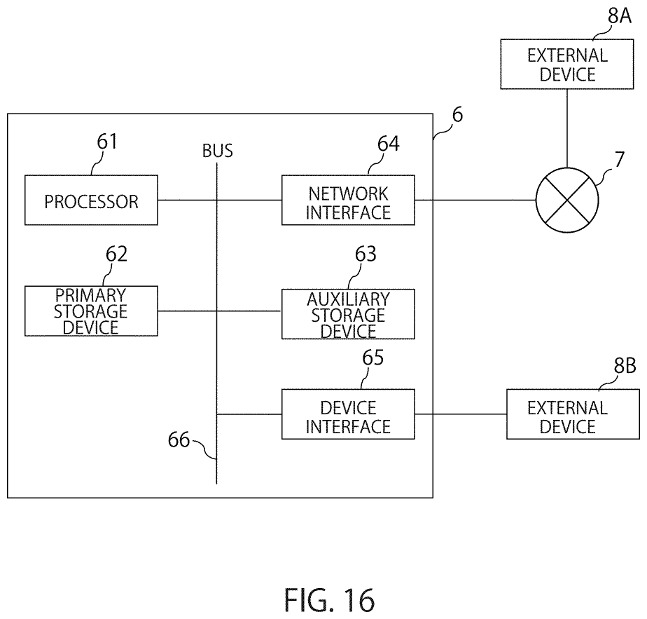

FIG. 16 is a block diagram illustrating one example of a hardware configuration of one embodiment of the present invention. The information processing apparatus 1 includes a processor 61, a PRIMARY STORAGE DEVICE 62, an AUXILIARY STORAGE DEVICE 63, a network interface 64, and a device interface 65 and is realized as a computer apparatus 6 in which those are connected together via a bus 66. The storage 101 is realizable by the PRIMARY STORAGE DEVICE 62 or the AUXILIARY STORAGE DEVICE 63, and the other constituent elements are realizable by the processor 61.

Note that the computer apparatus 6 in FIG. 16 includes one constituent element for each constituent element but may include the plural same constituent elements. Further, although FIG. 16 illustrates one computer apparatus 6, software is installed in plural computer apparatuses, and each of the plural computer apparatuses may execute a different portion of processing of the software.

The processor 61 is an electronic circuit including a control apparatus and a computation apparatus of the computer. The processor 61 performs computation processing based on data or a program input from each apparatus or the like of an internal configuration of the computer apparatus 6 and outputs a computation result or a control signal to each apparatus or the like. Specifically, the processor 61 executes an operating system (OS) of the computer apparatus 6, an application, and so forth and controls each apparatus configuring the computer apparatus 6.

The processor 61 is not particularly limited as long as the processor 61 may perform the above processing.

The PRIMARY STORAGE DEVICE 62 is a storage storing commands executed by the processor 61, various kinds of data, and so forth, and information stored in the PRIMARY STORAGE DEVICE 62 is directly read out by the processor 61. The AUXILIARY STORAGE DEVICE 63 is a storage other than the PRIMARY STORAGE DEVICE 62. Note that it is assumed that those storages mean arbitrary electronic components capable of storing electronic information and may be a memory or a storage. Further, a memory may be categorized into a volatile memory and a non-volatile memory, but either one may be used.

The network interface 64 is an interface for connection with the communication network 7 in a wireless or wired manner. The network interface 64 may be used which conforms to an existing communication standard. The network interface 64 may exchange information with an EXTERNAL DEVICE 8A with which communication connection is made via the communication network 7.

The device interface 65 is an interface such as a USB directly connected with an EXTERNAL DEVICE 8B. The EXTERNAL DEVICE 8B may be an external storage medium or a storage apparatus such as a database.

The EXTERNAL DEVICEes 8A and 8B may be output apparatuses. The output apparatus may be a display apparatus for displaying an image or may be an apparatus outputting sound or the like, for example. Examples may include a liquid crystal display (LCD), a cathode ray tube (CRT), a plasma display panel (PDP), a speaker, and so forth but are not limited to those.

Note that the EXTERNAL DEVICEes 8A and 8B may be input apparatuses. The input apparatus includes devices such as a keyboard, a mouse, and a touch panel and provides information input by those devices to the computer apparatus 6. A signal from the input device is output to the processor 61.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An information processing apparatus comprising:
a transformer configured to transform a text into entity data indicating entities and association among entities; and
a detector configured to detect a second text having a relationship with a first text by comparing first entity data transformed from the first text with one or more second entity data transformed from one or more second texts.

2. The information processing apparatus according to claim 1, wherein
the detector detects the second text by detecting that the second text has a relationship with the first text in a case where at least a portion of the first entity data is included in the second entity data.

3. The information processing apparatus according to claim 1, wherein
the transformer shapes the entity data by integrating together plural same entities included in the entity data, and
the detector compares shaped first entity data with shaped second entity data.

4. The information processing apparatus according to claim 1, further comprising an output device configured to output the entity data as a graph in a tree structure in which the entity is a node and the association between entities is a link.

5. The information processing apparatus according to claim 4, further comprising
a synthesizer configured to generate third entity data in which synthesis at least between the first entity data and the second entity data is performed, by integrating together at least entities included in both of the first entity data and the second entity data, wherein
the output device outputs the third entity data.

6. The information processing apparatus according to claim 5, wherein
when the third entity data are output, the output device changes display of an entity in the third entity data, the entity being common to the first entity data and the second entity data, such that the display is different from display of other entities.

7. The information processing apparatus according to claim 5, wherein
when the third entity data are output, the output device changes display of an entity in the third entity data, the entity being included only in the first entity data or the second entity data, such that the display is different from display of other entities.

8. The information processing apparatus according to claim 5, further comprising
an input device configured to accept designation of an entity in the third entity data, wherein
the detector detects a text corresponding to a designated entity, and
the output device outputs first information about a detected text or a document including the detected text.

9. The information processing apparatus according to claim 5, wherein
the detector detects a text corresponding to an entity included in the third entity data, and
the output device outputs a detected text.

10. The information processing apparatus according to claim 9, wherein
when the detected text is output, the output device changes display of a text corresponding to an entity common to the first entity data and the second entity data such that the display is different from display of other texts.

11. The information processing apparatus according to claim 9, wherein
when the detected text is output, the output device changes display of a text corresponding to an entity included only in the first entity data or the second entity data such that the display is different from display of other texts.

12. The information processing apparatus according to claim 5, wherein
the detector generates second information indicating whether an entity included in the third entity data is included in a targeted document or not, and
the output device outputs the second information.

13. An information processing method comprising:
transforming a text into entity data indicating entities and association among entities; and
detecting a second text having a relationship with a first text by comparing first entity data transformed from the first text with one or more second entity data transformed from one or more second texts.

14. A non-transitory computer readable medium storing a program, the program comprising:
transforming a text into entity data indicating entities and association among entities; and
detecting a second text having a relationship with a first text by comparing first entity data transformed from the first text with one or more second entity data transformed from one or more second texts.
